(19) United States
(12) Patent Application Publication
(10) Pub. No.: US 2007/0073613 A1
(43) Pub. Date: Mar. 29, 2007

(54) Simultaneous bidding and matching platform for loan borrower and lenders

(75) Inventor: Wen-Fu Lee, Taipei (TW)

Correspondence Address: BIRCH STEWART KOLASCH & BIRCH, PO BOX 747, FALLS CHURCH, VA, 22040-0747, US

(73) Assignee: ONGRAND LIMITED

(21) Appl. No.: 11/236,499

(22) Filed: Sep. 28, 2005

(51) Int. Cl. G06Q 40/00

(52) U.S. Cl. 705/38

(57) ABSTRACT

The present invention is a simultaneous bidding platform facilitate loan transactions process between borrowers and lenders. Matching module of the bidding and matching platform automatically match higher preferred interest-rate borrower bid sheet with lower preferred yield-rate lender bid sheet. The module generates bidding and matching loan borrowers' results, actual loan amount, actual interest-rate borrowers liable; and results of different lenders in various investment risk levels, actual invested amount and respective investment yield-rate per their risk levels. After matching results generated, all matched bidders perform their obligations according to the terms stipulated in the pre-signed bidding agreements as borrowers and lenders. The single matched borrowing bidder owes the matched loan amount and performs bidding obligation to all matched multiple lending bidders proportionally. The matched borrower acceptss the trustee pointed by all the matched lenders to custody collaterals, to escrow bidding agreements execution; and perform loan obligation through the trustee.

### BACKGROUND OF THE INVENTION

1. Field of the Invention

The present invention relates to a simultaneous bidding platform to facilitate loan transactions process between borrowers and lenders. The invention is, specifically, a bidding system or method that allows borrowers to obtain lower loan interest-rate than bank lending rate and allows lenders to obtain higher yield rate than bank saving rate.

2. The Related Art

Current loan transactions are using computer network as a data base to maintain related information about loan borrowers and lenders. Lenders are financial institutions such as banks or credit centers. Those said financial institutions obtain their profit by providing lower saving rate to these fund lenders and offering higher loan interest-rate to these fund borrowers. It is impossible for each individual fund borrower or lender to decide their loan interest rate or investment yield rate. The present inventions provide a mechanism to facilitate loan transaction process between borrowers and lenders and allow each individual find borrower or fund lender to determine his or her loan interest-rate and investment yield rate respectively.

Current financial institutions, like most profit-seeking businesses, have many branch offices to meet the service need of their customers. In order to maintain services to their customers, financial institutions need a great deal of human resources and facilities, which directly increase operation cost to financial institutions themselves and indirectly increase transaction cost to their fund borrower and decrease yield to their fund lenders. The present invention solves this problem by providing a mechanism for each individual, including borrowers and lenders, to act individually or to gather as a group for loan transactions. Functions of traditional financial institutions are replaced by a trust company as a trustee.

### SUMMARY OF THE INVENTION

The primary objective of the present invention is to provide a simultaneous bidding and matching platform for loan borrowers and lenders. The matching module of the bidding and matching platform will automatically match higher preferred interest-rate loan borrower bid sheets with lower preferred yield-rate loan lender bid sheets. The said module will also generate bidding and matching results of loan borrowers who receive the bid, actual loan amount that loan borrowers can get, and actual interest-rate that borrowers are liable for; and results of different lenders in various investment risk levels, actual invested amount of their shares of the loan and respective investment yield-rate per their risk levels.

After matching results are generated, all matched bidders will then perform their obligations according to the terms and conditions stipulated under the bidding agreements as borrowers and lenders. The single matched loan borrowing bidder owes the matched principal loan amount to all matched multiple loan lending bidders proportionally. Accordingly, the said loan borrower shall perform obligation of the principal amount of loan proportionally to those lenders.

A trust company is designated in the system. The trust company custody the bidding deposit per bidding agreement signed by all related bidders and escrows bidding agreements execution by all related bidders. Each loan lender shall transfer shared money to the matched borrower through the designated trust company and then entrust the loan to the trust company. Borrowers shall perform their loan obligations with collaterals through the trustee.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a block diagram of a simultaneous bidding platform for loan borrowers and lenders;

FIG. 2 shows the matching module for loan borrowers and lenders within the loan bidding platform of FIG. 1;

FIG. 3 shows each bidding application, including loan lending bid sheet and loan borrowing bid sheet, within the operation of the loan bidding platform of FIG. 1 and matching module of FIG. 2;

FIG. 4 shows a table of matching results of loan bidding;

FIG. 5A and FIG. 5B show a matching process for loan bidding;

Resembling symbols:

10 simultaneous bidding platform for loan borrowers and lenders;

12a-12e electronic device;

14a, 14c, 14e loan lenders;

14b, 14d loan borrowers;

16a, 16c, 16e loan lending bid sheet;

16b, 16d loan borrowing bid sheet;

20 loan demand module;

22 loan supply module; and

24 matching module.

### DETAILED DESCRIPTION OF THE PREFERRED EMBODIMENT

The primary objective of the present invention is to provide a bidding and matching platform for loan borrower and loan lender bid sheets simultaneously. The said platform uses state of art communication network to separately accept bidding applications from loan borrowers and lenders, and then further uses the matching module embedded within the servers of the network to automatically match higher interest-rate loan borrowing bid sheets with lower yield-rate loan lending bid sheets. The platform finally decides loan borrowers, amount of loan, actual interest rate for the loan, different loan investors in various risk levels, investor's actual invested amount for a particular matched loan per their shares, and actual investment yield for each loan investors.

One of secondary objects of the present invention is to provide a bidding and matching platform for loan borrowers and lenders to submit bidding sheets simultaneously. All bidders are requested to sign the bidding agreement and provide the bidding deposit. Borrowers are further requested to provide collateral as stipulated in bidding agreement. By doing this, bidders' rights and obligations are identical, and the bids can be grouped up and processed.

Another secondary objects of the present invention is to provide loan borrowers and lenders a bidding and matching platform which loan borrowers and lenders are grouped up under same rights and obligations, such as same loan interest rate or same investment yield, and conduct bidding to decide who has higher interest rate among bidding loan borrowers and who has lower yield rate among bidding loan lenders in the same group.

Based on above objectives, this invention also provides a loan demand module, a loan supply module, and a matching module.

The loan demand module will accept multiple loan borrowing bid sheets, and each loan borrowing bid sheet shall at least include preferred amount of loan and preferred interest rate of loan. The loan supply module will accept multiple loan lending bid sheets, and each sheet shall at least include various investment risk levels, respective preferred amount of investment, and respective preferred investment yield rate. Investment risk levels shall at least include the lowest risk level and a next higher risk level. Per bidding rules, matching module will automatically match loan borrowing bid sheets from those who have the highest preferred interest rate with loan lending bid sheets from those who have the lowest expect investment yield rate and next higher yield rate in the investment risk level range. In addition, the system will gradually decide who receive the bid for loan borrowing bid sheets and for loan lending bid sheets.

The following detailed description of embedment of this invention with the attached shall reveal advantage and benefit of this invention in a thorough manner.

The present invention is indeed a business method in its nature. However, the operation of this invention is extremely complicated, and can not be accomplished depending upon manual calculation. Therefore, this invention is a business method operated by a computer device and further qualified as a patentable object.

Before any bidding activity can be started, all the bidders are required to sign a bidding agreement. After matching results are generated, the single matched loan borrower has responsibility to all related loan lenders per their invested share of the loan to perform the obligation according to the terms and conditions stipulated under the bidding agreement.

As all the related loan lenders entrust loan and collaterals to a trustee appointed in the bidding agreement, the matched loan borrower shall accept the trustee and perform loan obligations through the trustee.

The present invention further provides a platform to combine funds from various risk-yield preference investors. The core concept is to conduct reasonable profit trade-off transactions among various risk levels investors to justify yields distributions. Investment risk level shall be clearly defined as priority order in debt carryback. The lower the investment risk level a lender chooses, the lower the loan pay off priority his investment will be. To match with the borrow side the platform aggregates lend side by matching all investment risk levels at a ratio preset in the bidding agreement. Subsequently, the platform shall then determine results of the bidding, at least including matched loan borrower, actual amount of loan, actual loan interest, matched different loan lenders in various risk levels, actual amount of investment per risk level, and actual investment yield rates per risk level. The following shall clearly illustrate how various risk levels are drawn, how the above results are generated from the platform, and finally the detailed information regarding bidding agreement of this platform and trust relationships between bidders and trustee.

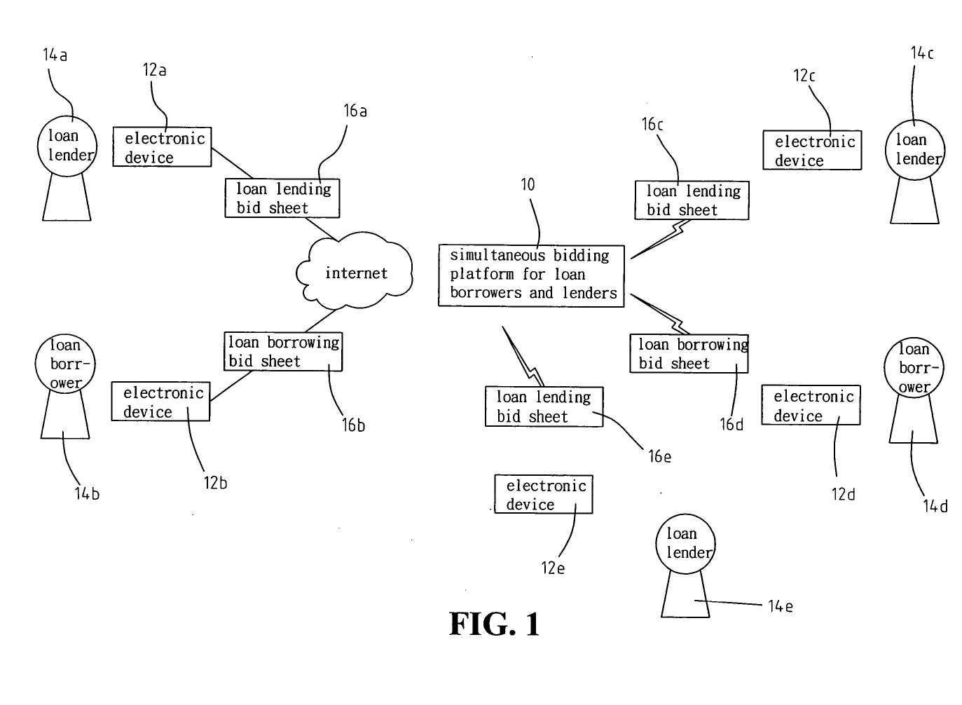

FIG. 1 represents a block diagram of a simultaneous bidding platform 10 for loan borrowers and lenders. As indicated in FIG. 1, loan borrowers 14b, 14d and lenders 14a, 14c, 14e apply for bidding through internet or communication network on the simultaneous bidding platform 10. By virtual of electronic devices 12c-12e, the said platform 10 accepts loan lending bid sheets 16a,16c,16e from loan lenders 14a, 14c, 14e, and loan borrowing bid sheets 16b,16d from loan borrowers 14b,14d. Specific attention needs to be drawn that numbers of borrowers and lenders shall not be limited to the number above mentioned, and general communication network shall be applicable to the above transactions.

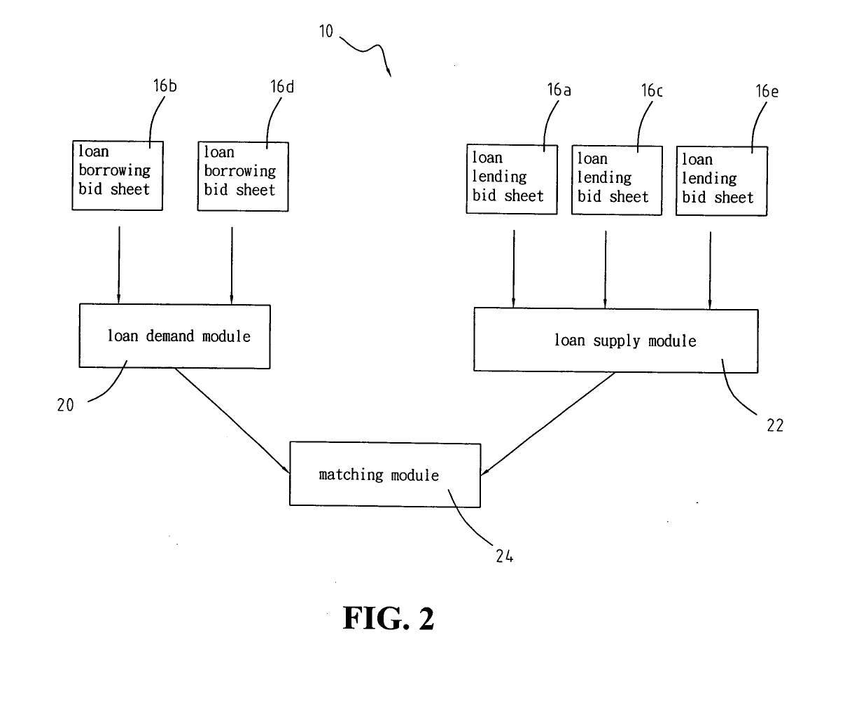

FIG. 2 represents the matching module 24 in the operation of the loan bidding platform 10 of FIG. 1. As indicated in FIG. 2, this invention provides a simultaneous bidding platform 10 for loan borrowers 14b, 14d and lenders 14a, 14c, 14e, which includes a loan demand module 20, a loan supply module 22, and a loan matching module 24.

The main function of the said loan demand module 20 is to receive multiple loan borrowing bid sheets 16b, 16d from borrowers, and the main function of the said load supply module 22 is to receive multiple loan lending bid sheets 16a,16c,16e. When the said loan demand module 20 and loan supply module 22 stop receiving bidding applications at the time originally set for termination of each bidding, the said matching module 24 will generate bidding results according to bidding rules.

All bidders, including loan borrowers 14b, 14d and lenders 14a, 14c, 14e, must sign a bidding agreement and provide bidding deposit to the trust company to validate their applications. Loan demand module 20 and loan supply module 22 of the platform shall verify each loan lender 14a,14c,14e and each loan borrower 14b, 14d by identifying their qualifications. Each lender and borrower will only be qualified after they complete all procedures via the designated trust company by signing bidding agreement and providing bidding deposit. Matching module 24 will only process applications submitted from qualified lenders and borrowers.

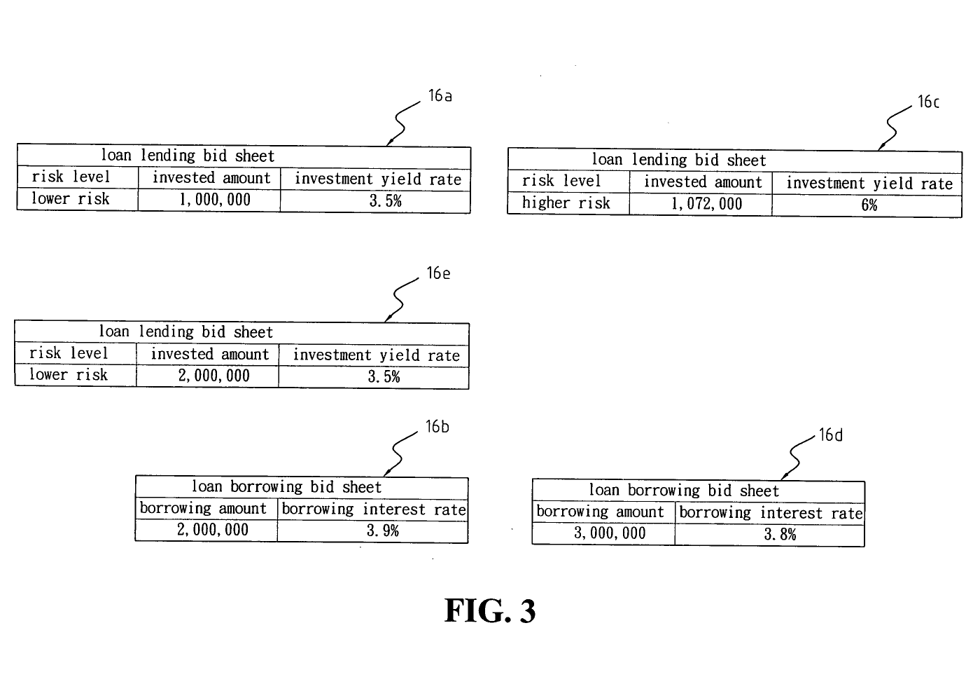

FIG. 3 represents bidding applications of this invention. As indicated in FIG. 3, each loan lending bid sheet 16a,16c,16e shall at least include a risk level, amount of investment and investment yield rate; each loan borrowing bid sheet 16b,16d shall at least include amount of loan and interest rate of loan.

In general, bidders will normally refer to information of banks and financial institutions for their investment yield rate and/or last bid loan interest rate before they file bid sheets. Lenders of loan investment are unlikely to accept yield rate lower than bank saving interest. Borrowers of loan are also unlike to accept loan interest rate higher than bank loan interest rate. Therefore, interest rate generated from this invention shall fall within the range of bank saving interest rate and bank loan interest rate.

Since credit limit of loan borrowers 14b, 14d will vary depending upon his/her collateral provided, the loan amount in the loan borrowing bid sheets 16b, 16d will then be within each loan borrower's credit limit respectively.

For purpose of standardizing loan risk for investors' valuation, qualified collaterals and ratio of value of collateral verse loan limit shall be formally described on bidding agreements and public bidding announcement. For example, each bid amount is limited to 50% value of qualified estate collateral.

The unique feature of loan lending from various risk levels is a specific design within the present invention. With this specific feature, those who are willing to bear higher risk shall be able to obtain higher yield rate, and those who is not willing to bear higher risk shall trade off some yield (referred as premium) to those who willing to bear higher risk. In the case of any loan borrower failing to pay for the loan interest and/or principle of loan, the lenders will be distributed the money in sequence according to their priority per their shares without delay. This is a special design to attract investors with different risk-yield preference. The following is an example illustrating the above design.

The loan lender 14a is not willing to bear high risk of this loan investment. Therefore, apart from filling amount of investment as $1,000,000 and investment yield rate of 3.5%, the said loan lender 14a shall also fill his preferred investment risk level as the lowest one in the loan lending bid sheet 16a. The loan lender 14c, who files a loan lending bid sheet 16c, is willing to bear higher risk of this loan investment. Therefore, the loan lender 14c may set his loan lending bid sheet 16c with higher risk level for high yield rate. With respect to loan borrower 14b, 14d, they do not need to consider risk level for their loan transactions, and all they have to do is to fill in amount of loan and loan interest rate in their loan borrowing bid sheets 16b, 16d.

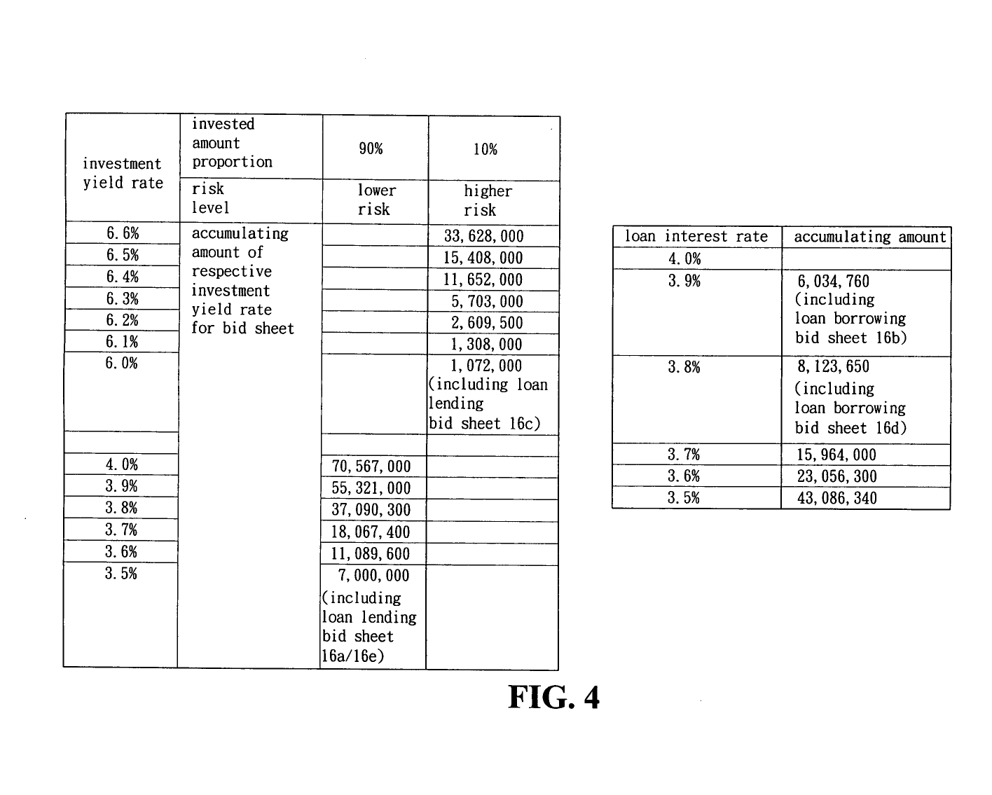

FIG. 4 represents process of bidding sheets of this invention. As indicated in FIG. 4, after the loan demand module 20 and loan supply module 22 receive all bid sheets, matching module 24 will start to match all applications according to lending side yield rate and borrowing side interest rate, or accumulating amount of loan by adding up applications with same yield or interest rate. As indicated in FIG. 4, loan lending bid sheets 16a and 16c are applied in different sequence and time. These two bid sheets are still listed together as they are in the same investment yield rate 3.5%. Loan borrowing bid sheets 16b and 16d are in different loan interest rate, so these two bid sheets are not listed together. Attention has to be drawn that although risk levels in the above example are only listed as higher and lower risk levels, it is definitely possible for risk levels to be listed in more detailed and different levels.

The matching module 24 of the bidding and matching platform will then match higher loan interest-rate borrowing bid sheets with lower yield-rate lending bid sheets. Therefore, within the FIG. 4, the highest interest-rate loan borrowing bid sheet is 16b. The lowest yield-rate with lowest risk level loan lending bid sheets are 16a and 16e, and the lowest yield-rate with higher risk level loan lending bid sheet is 16c. Except for loan lending bid sheet 16c, other loan lending bid sheets 16a and 16e, loan borrowing bid sheet 16b are only part of total lend amount of their respective yield rate, which means remaining lend amount of their respective yield rate are to be matched to other loan borrowing bid sheets later. Of course, loan lending bid sheets 16a, 16e, and 16c would be firstly matched with loan borrowing bid sheet 16b and not according to the time when the bid sheets are made. Anyway, matching rule is that the matching module 24 of the bidding and matching platform will match higher interest-rate loan borrowing bid sheets with lower yield-rate loan lending bid sheets.

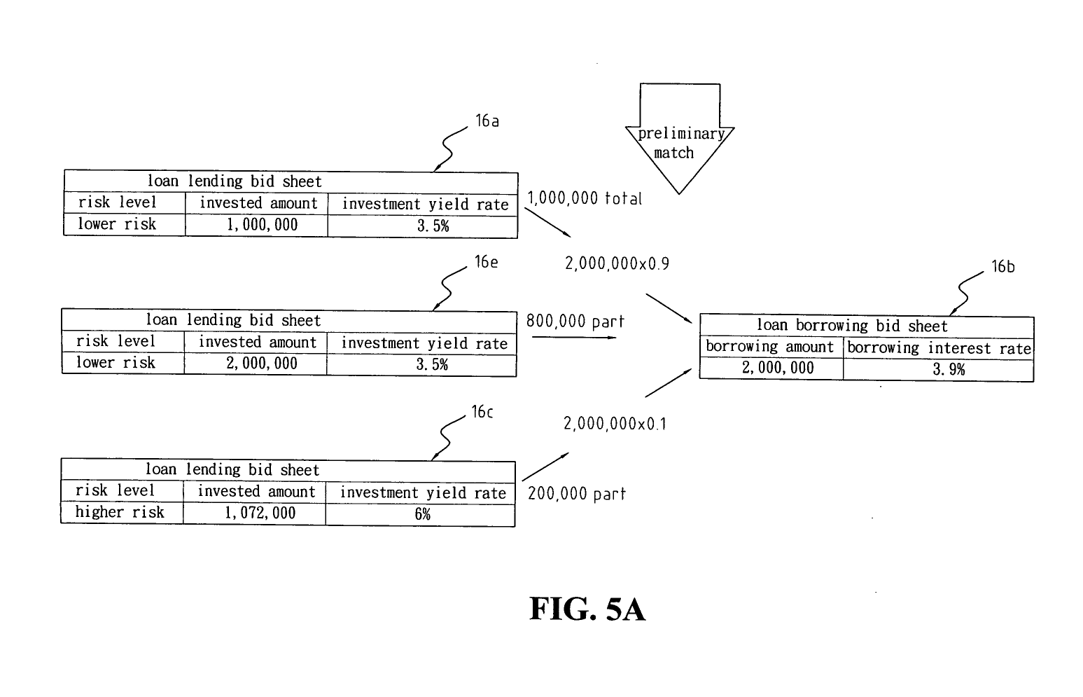

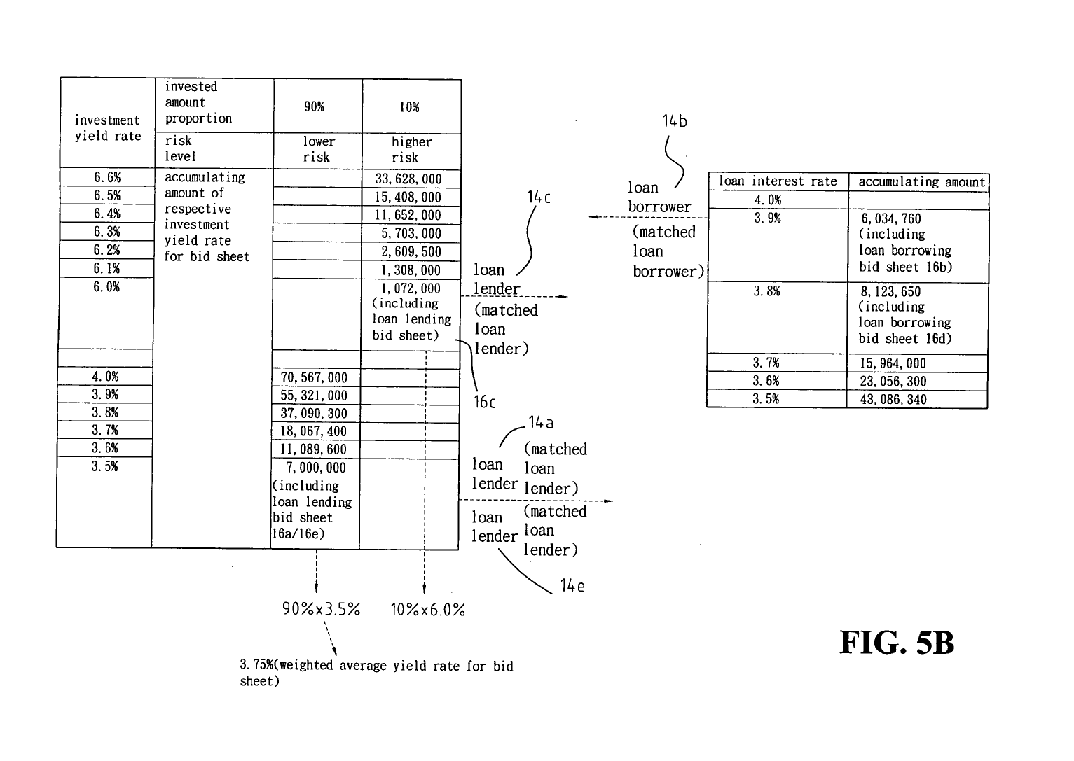

Please refer to FIGS. 5A and 5B which indicate the matching process for loan bidding. The matched borrower's loan amount is accumulated from the different risk level of matched invested bidders based on the proportion stipulated in the bidding agreement. Therefore, as indicated in FIG. 5A, when matching module 24 started to conduct matching process, it will automatically calculate and ask various risk levels investment loan lending bid sheets 16a, 16e, and 16c to provide loan proportionally. For example, loan borrowing bid sheet 16b needs amount of loan as $2,000,000, the lowest risk level loan lending bid sheets 16a and 16e, will provide 90% (that is $2,000,000×0.9) of loan amount and 16c 10% (that is $2,000,000×0.1). Moreover, as loan lending bid sheet 16a is filed earlier, its total investment capital $1,000,000 would be matched by the system in full, and the remaining $800,000 loan will be filled in by later loan lending bid sheet 16e. After then, the remaining $200,000 will be provided by loan lending bid sheet 16c in full. To sum up, investment amount of loan lending bid sheets 16a, 16e, and 16c are $1,000,000, $800,000 and $200,000 respectively, and loan amount of loan borrowing bid sheet 16b is the original number bidden by the loan borrower 14b. It has to be noted that, if collateral is undividable, the borrowing bid sheet has to be matched in full and not partially.

After above matching process, another important criterion has also be taken into consideration, that is, whether the interest-rate is satisfied by both borrowers and lenders in the following:

Matched borrow interest rate>=Σ(Matched lend amount×yield-rate of respective applications)/Σ(Matched lend amount)

For example, as indicated in FIG. 5B, weighted average yield rate for loan lending bid sheets 16a, 16e, and 16c is 3.75% ($1,000,000×3.5%+$800,000×3.5%+$200,000×6.0%)/$2,000,000. Therefore, for those loan lending bid sheets 16a, 16e, and 16c matching with loan borrowing bid sheet 16b, their weighted average yield rate does not exceed target interest rate 3.9% of loan borrowing bid sheet 16b. The matching module 24 will then decide loan lending bid sheets 16a, 16e, and 16c of loan lenders 14a, 14e, and 14c respectively match with loan borrowing bid sheet 16b of loan borrower 14b. Bidding results for amount will then be generated.

After above matching process, as total amount of loan lending bid sheets 16a, 16e, and 16c exceed demand amount of loan borrowing bid sheet 16b, remaining amount of loan lending bid sheet 16e will have priority in next matching process. In other words, the remaining amount of loan lending bid sheet 16e will become lower yield-rate lending bid sheets to be matched first with higher interest rate loan borrowing bid sheets. The same criteria, borrower's interest-rate no less than lenders' yield-rate, will also be applied in repeating the above matching process for the remaining bid sheets.

In the process of assigning the interest rate or yield rate to those matched bidders, there may be the following options: (1) the interest rate or yield filed in the bid sheet is applied to bidder's specific loan agreement; or (2) the marginal interest rate is applied to bidder's specific loan agreement. In the first case, the portfolio borrowing interest rate will be greater than the portfolio investment yield rate; the difference of those two rates will be treated as platform provider's income. In the second case, the portfolio borrowing interest rate will be equal to the portfolio investment yield rate; the platform provider can not earn any income from the difference.

In the second case, the borrowing interest rate and investment yield rates shall then be calculated as following:

A. Interest rate of the last matched loan borrowing bid sheet shall apply to all matched loan borrowing bid sheets.

B. Except for those of the highest risk level, yield rate of the last matched loan lending bid sheet shall apply to all matched loan lending bid sheets in that risk level.

C. Interest income of the highest risk level investment=(Total interest to be paid by matched loan borrowing bid sheet)−(Total interest income of other risk levels investment)

D. Yield rate of the highest risk level investment=(Interest income of the highest risk level investment)/(Total amount of the matched highest risk level loan lending bid sheets)

Profit trade-off among various risk levels are further illustrated following. For those who are willing to bear higher risk will also have the possibility of obtaining higher yield rate. For those who are unwilling to bear such high risk, this platform shall trade off part of their yield into the status as Priority creditor. The difference between borrowing interest rate and Priority creditor yield is Priority Premium. Premium trading activity is as following:

Total interest income

=Interest income of the lower risk level investments+Interest income of the highest risk level investment

=Total amount of loans×0.9× the lower risk level yield rate+total amount of loans×0.1× the highest risk level yield rate

=Total amount of loans×0.9×(borrowing interest rate−Priority Premium)+Total amount of loans×0.1×(borrowing interest rate+Priority Premium×(0.9/0.1)) Priority Premium=Borrowing interest rate−The lower risk level yield rate

The above illustration is an example of taking fixed term in bidding, selection and match process in interest rates. However, the present invention is not binding in the fixed term. When a variable term such as markup toward an indexed rate (for example, one year bank CD interest rate) is used, the number used in selection and match process will be the markup number. Using indexed rate markup can help both parties (borrower and lender) to avoid risk of interest fluctuation during the loan contract period because the interest paid and received will be adjusted per indexed rate. If the variable term as the markdown toward indexed rate (for example: bank loan prime rate) is used, the number used in selection and match process will be the balance of indexed rate subtracts markdown. And the same economical benefit will be achieved as the markup term.

According to above illustrations, this simultaneous bidding platform 10 is a platform for those bearing various obligations and rights to file their bids within the same group under same category (namely interest) and same unit (namely interest rate). The matching mechanism of this platform is mainly functioning by matching those borrowers who are willing to offer higher interest rate in their loan borrowing bid sheets with those investors who are willing to obtain lower yield rate in their loan lending bid sheets. Matching process of the said mechanism is accomplished by way of internet communication network as indicated in FIG. 1. The platform will receive bidding applications from borrowers and lenders respectively and simultaneously. Matching module of the platform will match bid sheets and subsequently generate results of a bid, including loan borrowers, lenders in different risk levels, actual amount of loan of each borrower, actual interest rate to be paid by the said borrower, actual invested amount of lenders, and actual yield rate to be received by the said lenders. Besides, borrowers and investors will have to sign an agreement for the bidding prior to applying for the actual bidding applications, and bidding deposits are requested to all bidders in order to maintain orders of transactions.

The preferred interest rate of the last bidding bid sheets successfully matched will be applied to all matched sheets as their interest rate in the same group, except for the highest risk level applications group. Per the rule, another yield rate will be calculated accordingly and shall be further applied to those matched highest risk level bid sheets.

To enforce the bidding agreement, the bidding amount as showing in the loan lending bid sheet owned by matched loan lender, which is proportion of total amount of every loan lending bid sheet in the same risk degree, the matched loan lender shall provide the actual investment amount to every matched loan borrower, and becomes the joint creditor with the other matched loan lenders to the matched loan borrower proportionally, while the matched loan borrower obtains the actual loan amount based on the bidding agreement and property collateral. As indicated in FIGS. 5A and 5B, a single lending bid sheet 16a with other loan bid sheets jointly obtain the credit and property collateral of all borrowers.

The borrowing bidders must provide the value-appraised property collateral before delivering the loan borrowing bid sheet to the loan demand module 20.

The lending bidders agree that as the trust company collects credit and pays off the lenders, proceeding from all borrowers should be aggregated as a whole, then distributed to lenders in the priority according to their risk level status. And if collections from any term in pay off schedule is not enough paying the due amount of the lower risk levels, the trust company should pending pay-off to the higher risk level lenders until all the lower risk levels' due amount, including delay payment interest fully paid off. Such pending will effect in the rest term of pay off schedule.

The trust company signs a trust contract with lending bidder, before bidder delivering loan lending bid sheet to loan supply module 22. If approved by the government agency, this trust contract is a mutual fund trust contract itself, and loans to all borrowers are treated as fund assets.

If a bidding agreement is invalided, default or the bidder violate the bidding agreement, the owner of bidding platform is entitled to handle the bidding deposit according to the bidding agreement and subsidizes the deposit to the second match bidder or to the counterparties who has already performed the agreement.

A single matched loan lender shall distribute the amount to all matched loan borrowers, trust to the trust company with money credit and property collateral that incurring from the bidding agreement, and authorizing the trust company collecting credits.

The matched loan borrower may pay off their loan prior to the expiration of agreement, provided early withdrawal penalty shall be applied and all amount of penalty shall be split among all lenders proportionally per lenders' invested contributions to the loan. The simultaneous bidding platform 10 also provide checking mechanism for collateral statistics, risk levels, records of previous bids, data of potential bidders, qualified bidders, applications acceptance, alert function for ending of bidding time, announcement to each individual regarding bidding results, and online checking for bidders.

Although the present invention has been described with reference to the preferred embodiments thereof, it is apparent describing the feature and spirit of the invention, while a variety of modifications and changes are made without departing from the scope of the present invention which is intended to be defined by the claims.

What is claimed is:

1. The present invention relates to a simultaneous bidding platform determining about a matched loan borrower, a different risk levels' matched loan lenders, the actual loan amount, actual loan interest rate for the matched loan borrower, and each actual loan amount contribution of the invested amount and investment yield rate of the matched loan lender. The said platform comprises:
a loan demand module, the said module is to receive multiple loan borrowing bid sheets, and the bid sheet shall at least include the information about the amount of loan needed and interest rate for the loan;
a loan supply module, the said module is to receive multiple loan lending bid sheets, and the said bid sheet shall at least include the information about the investment amount and preferred yield rate for different risk levels, and the said risk level data shall at least has the lowest risk level and next higher risk level;
a matching module, the said module is to match the highest interest rate bid sheet from all loan borrowing bid sheets with the lowest yield rate bid sheets and subsequently to second lower from respective risk levels of loan lending bid sheets proportionally, and as a result generating results of each matched bid.

2. The simultaneous bidding platform as claimed in claim 1, wherein the actual amount of loan to the loan borrower is aggregated amount from various risk levels loan lenders contributed per the portion they proportionally share in the total amount of loan.

3. The simultaneous bidding platform as claimed in claim 1, wherein the risk level is defined as if the loan borrowers not perform the loan due amount that stipulated in the bidding agreement, what priority a matched lender is entitled to accept pay off among all matched loan lenders from total proceeding collected.

4. The simultaneous bidding platform as claimed in claim 1, wherein the matching module matches all bid sheets according to the following rules: preliminarily matching the highest interest rate of loan borrowing bid sheets with those lowest yield rate from different risk levels of loan lending bid sheets which have not yet been matched and whose amount is also sufficient to form part of the loan and then screening out those preliminary loan lenders who together provide a weighted-average yield rate higher than the preliminary loan borrower interest rate, each owner of the remaining loan lending bid sheet is capable of mutually providing the loan amount who will become the matched loan lender to the loan borrowing bid sheet, while the owner of loan borrowing bid sheet becomes the matched loan borrower.

5. The simultaneous bidding platform as claimed in claim 4, wherein, within those loan borrowing bid sheets having the same interest rate or those loan lending bid sheets having the same yield rate, the earlier borrowing bid sheet or lending bid sheet will be first matched in the process.

6. The simultaneous bidding platform as claimed in claim 4, wherein among all matched loan lenders who have the lower risk level bearing, their profits shall be deducted by its priority premium value, and then transfer the said priority premium value to those matched loan lenders willing to bear higher risk level.

7. The simultaneous bidding platform as claimed in claim 4, wherein, during the preliminary matching process, the aggregated invested amount of matched loan lenders with lowest yield rate in different risk level if exceeds the required loan amount with the highest interest rate, the said exceeded amount with lowest yield rate shall be first matched as priority in next match.

8. The simultaneous bidding platform as claimed in claim 4, wherein during the preliminary matching process, the aggregated invested amount of matched loan lenders with lowest yield rate in different risk level is insufficient to meet the required amount with the loan having the highest interest rate, then the loan difference will be taken into match by those loan lenders having second lowest yield rate in respective risk level.

9. The simultaneous bidding platform as claimed in claim 4, wherein the last successful matched loan borrower bid sheet, its interest rate shall be applied to all matched loan borrowing bid sheets in that bidding; wherein the last successful matched lowest yield rate of bid sheet in respective risk levels other than the highest risk level, its yield rate shall be applied to the matched bid sheets in that risk level, and calculating the difference of interest and distributing which to all highest risk level matched bid sheets.

10. The simultaneous bidding platform as claimed in claim 2, wherein, the proportions of every matched loan lending amount to the total amount in the same risk level and all the risk levels, are applied for the trust company to distribute the lender's bid amount to each matched borrower, effecting the lenders as the joint creditor with the other matched loan lenders to the matched loan borrower proportionally, while the matched loan borrower obtains the actual loan amount based on the bidding agreement and property collateral.

11. The simultaneous bidding platform as claimed in claim 1, wherein, before delivering the loan borrowing bid sheet to the loan demand module, the borrowing bidders must promise to provide the value-appraised property collateral at least equals to the loan amount as stipulated in the bidding agreement.

12. The simultaneous bidding platform as claimed in claim 1, wherein, before delivering loan lending bid sheet to loan supply module, the lending bidders agree that as the trust company collects credit and pays off the lenders, proceeding from all borrowers should be aggregated as a whole, then distributed to lenders in the priority according to their risk level status. And if collections from any term in pay off schedule is not enough paying the due amount of the lower risk levels, the trust company should pending pay-off to the higher risk level lenders until all the lower risk levels' due amount, including delay payment interest fully paid off. Such pending will effect in the rest term of pay off schedule.

13. The simultaneous bidding platform as claimed in claim 1, wherein, the trust company signs a trust contract with lending bidder, before bidder delivering loan lending bid sheet to loan supply module. If approved by the government agency, this trust contract is a mutual fund trust contract itself, and loans to all borrowers are treated as fund assets.

14. The simultaneous bidding platform as claimed in claim 1, wherein, before delivering loan lending bid sheet to loan supply module, if a bidding agreement is invalided, default or the bidder violate the bidding agreement, the owner of bidding platform is entitled to handle the bidding deposit according to the bidding agreement and subsidizes the deposit to the second match bidder or to the counterparties who has already performed the agreement.

15. The simultaneous bidding platform as claimed in claim 1, wherein the loan match module determining about a matched loan borrower, a different risk levels' matched loan lenders, the actual loan amount, actual loan interest rate for the matched loan borrower, and each actual loan amount contribution of the invested amount and investment yield rate of the matched loan lender. All matched bidders will then perform their obligations according to the terms and conditions stipulated under the pre-signed bidding agreements as borrowers and lenders. The single matched loan borrowing bidder owes the matched principal loan amount and perform bidding agreement obligation to all matched multiple loan lending bidders proportionally. The matched loan borrower shall accept the trustee pointed by all the matched loan lenders to custody collaterals and to escrows bidding agreements execution; and perform his/or her loan obligation through the trustee.

16. The simultaneous bidding platform as claimed in claim 1, wherein a single matched loan lender shall distribute the amount to all matched loan borrowers, trust to the trust company with money credit and property collateral that incurring from the bidding agreement, and authorizing the trust company collecting credits.

17. The simultaneous bidding platform as claimed in claim 1, wherein the matched loan borrower may pay off their loan prior to the expiration of agreement, provided early withdrawal penalty shall be applied and all amount of penalty shall be split among all lenders proportionally per lenders' invested contributions to the loan.

18. The simultaneous bidding platform as claimed in claim 1, where in the functions of the platform may include following further mechanisms:
Inquiry of collateral statistics,
Inquiry of risk levels,
Inquiry of the records of previous bids,
Data of potential bidders,
Qualified bidders,
Bidding sheet acceptance,
Alert function before the expiration of bidding,
Announcement to each individual regarding bidding results,
Online checking function for bidders.

19. The simultaneous bidding platform as claimed in claim 1, wherein loan borrowers and lenders file theirs bids through an electronic device with communication protocol into the loan demand/supply module.

20. The simultaneous bidding platform as claimed in claim 19, wherein the electronic device can be a PDA, a mobile phone, a PC or other electronic devices compatible with communication protocol.

21. The simultaneous bidding platform as claimed in claim 19, wherein the communication protocol can be an internet or telecommunication network.
